(19) United States
(12) Patent Application Publication
(10) Pub. No.: US 2016/0014610 A1
(43) Pub. Date: Jan. 14, 2016

(54) Licensed Band Feedback for Unlicensed Band Communication

(71) Applicants: Shin Horng Wong, Chippenham (GB); Teck Hu, Melbourne, FL (US)

(72) Inventors: Shin Horng Wong, Chippenham (GB); Teck Hu, Melbourne, FL (US)

(21) Appl. No.: 14/328,517

(22) Filed: Jul. 10, 2014

(51) Int. Cl. H04W 16/14; H04W 74/08

(52) U.S. Cl. CPC H04W 16/14; H04W 74/0808

(57) ABSTRACT

A node for wireless communication to provide, over a licensed frequency band, an indication of whether at least one unlicensed frequency band is clear for wireless communication. A node for wireless communication to receive, over a licensed frequency band, an indication of whether at least one unlicensed frequency band is clear for wireless communication.

### CROSS REFERENCE TO RELATED APPLICATIONS

This application is related to U.S. patent application Ser. No. ______, filed on ______.

### BACKGROUND

1. Field of the Disclosure

The present disclosure relates generally to wireless communication and, more particularly, to wireless communication in unlicensed frequency bands.

2. Description of the Related Art

Unlicensed frequency bands are portions of the radiofrequency spectrum that do not require a license for use and may therefore be used by any device to transmit or receive radiofrequency signals. For example, the industrial, scientific, and medical (ISM) radio bands are portions of the radio spectrum that are reserved internationally for unlicensed communication. The ISM radio bands include bands with a center frequency of 2.4 GHz and a bandwidth of 100 MHz, a center frequency of 5.8 GHz and a bandwidth of 150 MHz, and a center frequency of 24.125 GHz and a bandwidth of 250 MHz, among other frequency bands. Unlicensed frequency bands can be contrasted to licensed frequency bands that are licensed to a particular service provider and may only be used for wireless communication that is authorized by the service provider. Wireless communication devices that transmit or receive signals in unlicensed frequency bands are typically referred to as nodes. For example, the base stations or access points that provide wireless connectivity to a network and the user equipment or other devices that access the network over an air interface to the base stations or access points may be referred to as nodes in the wireless communication system.

Wireless communication systems that utilize unlicensed frequency bands, such as Wi-Fi systems, are prone to a “hidden node problem.” For example, if two user equipment are within range of the same access point, but are too far apart to be aware of each other, the two user equipment are “hidden” from each other. Access points or base stations can also be hidden from each other. Nodes that are hidden from each other cannot coordinate transmission and reception of packets, e.g., to force time-sharing between the two nodes. Packets transmitted by nodes that are hidden from each other may therefore collide at a receiving node, which can only decode one packet at a time. Consequently, packets intended for the receiving node may be missed or lost if they collide with other packets transmitted by a hidden node. The hidden node problem can be exacerbated by the presence of obstructions between the stations for the access points. For example, building penetration losses are typically on the order of 11-20 dB. Consequently, an indoor access point may be hidden from an outdoor base station even though they may be physically proximate to each other. Similarly, two user equipment in the same building may be hidden from each other if they are separated by one or more walls, doors, or other obstructions within the building.

A carrier sense multiple access (CSMA) protocol may be used to detect or avoid collisions that may be caused by the hidden node problem. In CSMA, a transmitting node monitors a channel in the unlicensed band to determine whether it is currently being used for other transmissions and only transmits if the channel is unoccupied. The CSMA protocol may be enhanced using a request-to-send/clear-to-send (RTS/CTS) protocol. The RTS/CTS protocol attempts to reduce collisions by allowing a transmitting node to send an RTS frame that indicates that the transmitting node would like to transmit information to a receiving node if the transmitting node detects a clear unlicensed channel. If the receiving node also determines that the unlicensed channel is clear, the receiving node replies with a CTS frame that indicates that the transmitting node is free to transmit information on the unlicensed channel for a time interval. Other nodes that detect the CTS frame are to refrain from transmitting on the unlicensed channel during the time interval indicated in the CTS frame. However, the time required to sense channels at the nodes and to exchange RTS/CTS messages introduces undesirable delays in communication between the nodes, which makes this approach unsuitable for delay-sensitive communication in unlicensed frequency bands.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a first example of a wireless communication system according to some embodiments.

FIG. 2 is a diagram of a second example of a wireless communication system according to some embodiments.

FIG. 3 is a diagram of a third example of a wireless communication system according to some embodiments.

FIG. 4 is a signaling diagram that illustrates a conventional request-to-send/clear-to-send (RTS/CTS) signal flow for communication in an unlicensed frequency band.

FIG. 5 is a signaling diagram that illustrates a first example of a signal flow for configuring proactive monitoring and reporting for an unlicensed frequency band according to some embodiments.

FIG. 6 is a signaling diagram that illustrates a second example of a signal flow for configuring proactive monitoring and reporting for an unlicensed frequency band according to some embodiments.

### DETAILED DESCRIPTION

Latency of transmissions in unlicensed frequency bands can be reduced without increasing interference between nodes by configuring a node to proactively provide an indication of availability of one or more unlicensed frequency bands over a licensed frequency band. Some embodiments of the nodes may proactively provide the indication of availability of the unlicensed frequency bands prior to data becoming available for transmission to the node over the unlicensed frequency bands. The bandwidth available to communicate data between nodes may be increased by supplementing the available licensed data channels with channels in the unlicensed frequency bands. For example, user equipment may be configured to communicate with a base station in a licensed frequency band according to agreed-upon industry standards such as the Long Term Evolution (LTE) standards defined by the Third Generation Partnership Project (3GPP). The base station may also provide supplemental downlink communications to the user equipment over an unlicensed frequency band such as the 5 GHz ISM unlicensed frequency band. The base station may therefore configure the user equipment to monitor one or more unlicensed frequency bands and provide signals indicating whether the unlicensed frequency bands are clear for supplemental downlink transmissions. If data arrives at the base station for transmission to the user equipment, the base station may transmit the data to the user over the unlicensed frequency bands if the signaling from the user equipment indicates that they are clear.

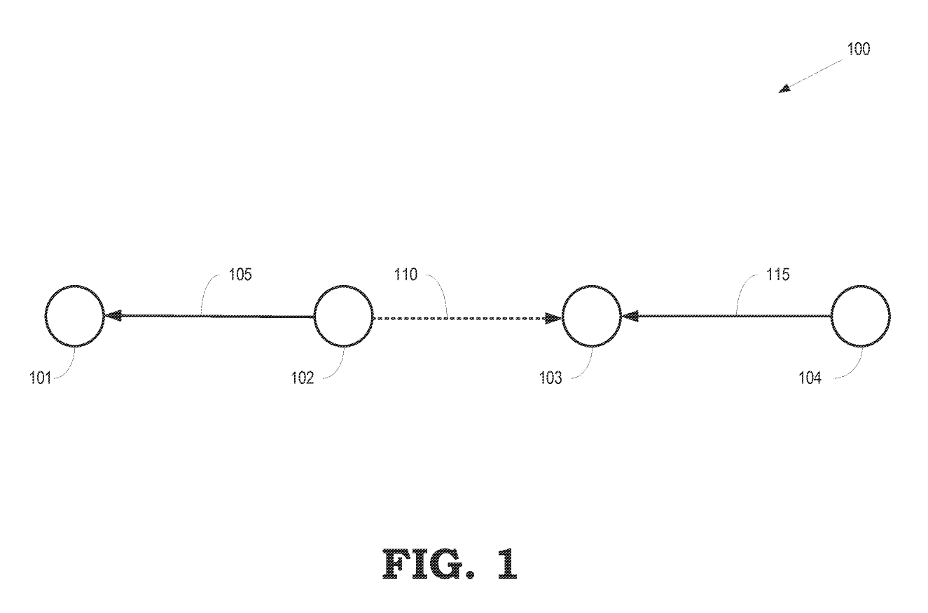

FIG. 1 is a diagram of a first example of a wireless communication system 100 according to some embodiments. The wireless communication system 100 includes a plurality of wireless communication nodes 101, 102, 103, 104 (collectively referred to herein as “the nodes 101-104”). Embodiments of the nodes 101-104 may be wireless transceivers such as access points or stations. For example, the nodes 101, 103 may be stations such as mobile units, mobile terminals, user equipment, access terminals, and the like. The nodes 102, 104 may be wireless access points for providing wireless connectivity to the notes 101, 103. The nodes 102, 104 may be also be referred to as base stations or eNodeBs. The nodes 102, 104 may transmit signals over a downlink (or forward link) to the nodes 101, 103. The nodes 101, 103 may transmit signals over an uplink (or reverse link) to the nodes 102, 104.

The nodes 101-104 may be configured to communicate over an air interface in licensed frequency bands or unlicensed frequency bands. As used herein, the phrase “unlicensed frequency band” will be understood to refer to a portion of the radiofrequency spectrum that does not require a license for use and may therefore be used by any of the nodes 101-104 to transmit or receive radiofrequency signals. For example, unlicensed frequency bands may include, but are not limited to, the industrial, scientific, and medical (ISM) radio bands that are reserved internationally for unlicensed communication. Unlicensed frequency bands may be defined by a center frequency bandwidth. For example, the ISM radio bands include bands with a center frequency of 2.4 GHz and a bandwidth of 100 MHz, a center frequency of 5.8 GHz and a bandwidth of 150 MHz, and a center frequency of 24.125 GHz and a bandwidth of 250 MHz, among other frequency bands. As used herein, the phrase “licensed frequency band” will be understood to refer to a portion of the radiofrequency spectrum that is licensed to a particular service provider or providers and may only be used for wireless communication by the nodes 101-104 that are authorized by the service provider. For example, the United States Federal Communication Commission (FCC) licenses the frequency bands 698-704 MHz and 728-734 MHz to Verizon Wireless and the frequency bands 710-716 MHz and 740-746 MHz to AT&T.

Nodes 102, 104 may be operated by different service providers or may operate according to different protocols (e.g., LTE or IEEE 802.11) and consequently the nodes 102, 104 may not be able to coordinate downlink transmissions in the unlicensed frequency band. Moreover, the nodes 102, 104 may be hidden from each other due to their separation or due to obstructions (not shown in FIG. 1) that are interposed between the nodes 102, 104. In the illustrated embodiment, the node 102 is associated with the node 101 and is attempting to communicate with the node 101 by transmitting packets over a downlink channel of the unlicensed frequency band, as indicated by the arrow 105. For example, the node 101 may have registered for Wi-Fi communications with the node 102 according to the 802.11 standards. Signals transmitted by the node 102 over the downlink channel in the unlicensed frequency band may also be received by the node 103, as indicated by the dotted line 110. The node 104 may also be attempting to transmit packets over the downlink channel of the unlicensed frequency band to the node 103, as indicated by the arrow 115. The node 104 may also be able to communicate with the node 103 over uplink or downlink channels of the licensed frequency band, e.g., according to LTE standards.

In order to prevent, or at least reduce the probability of, collisions between packets transmitted over the downlink channel of the unlicensed frequency band by the nodes 102, 104, the node 104 may use the licensed frequency band to configure the node 103 to proactively monitor the unlicensed frequency band to determine whether the unlicensed frequency band is clear for wireless communication. As used herein, the term “clear” will be understood to indicate that a measured value of a parameter of signals in the unlicensed frequency band (such as a signal-to-noise ratio, received signal strength indicator, and the like) is below a threshold value indicating that the unlicensed frequency band is clear of transmissions by other nodes and packets transmitted over a channel of the unlicensed frequency band are unlikely to collide with packets transmitted by other nodes. Some embodiments of the node 103 may begin monitoring the unlicensed frequency band prior to data becoming available at the node 104 for transmission to the node 103 and may provide signals to the node 104 indicating whether the unlicensed frequency band is clear. Thus, if the node 103 has proactively indicated that the unlicensed frequency band is clear, then node 104 may transmit information in the unlicensed frequency band as soon as data becomes available for transmission to the node 103. Some embodiments of the node 104 optionally verify that the unlicensed frequency band is clear by sensing the unlicensed frequency band before transmitting the data.

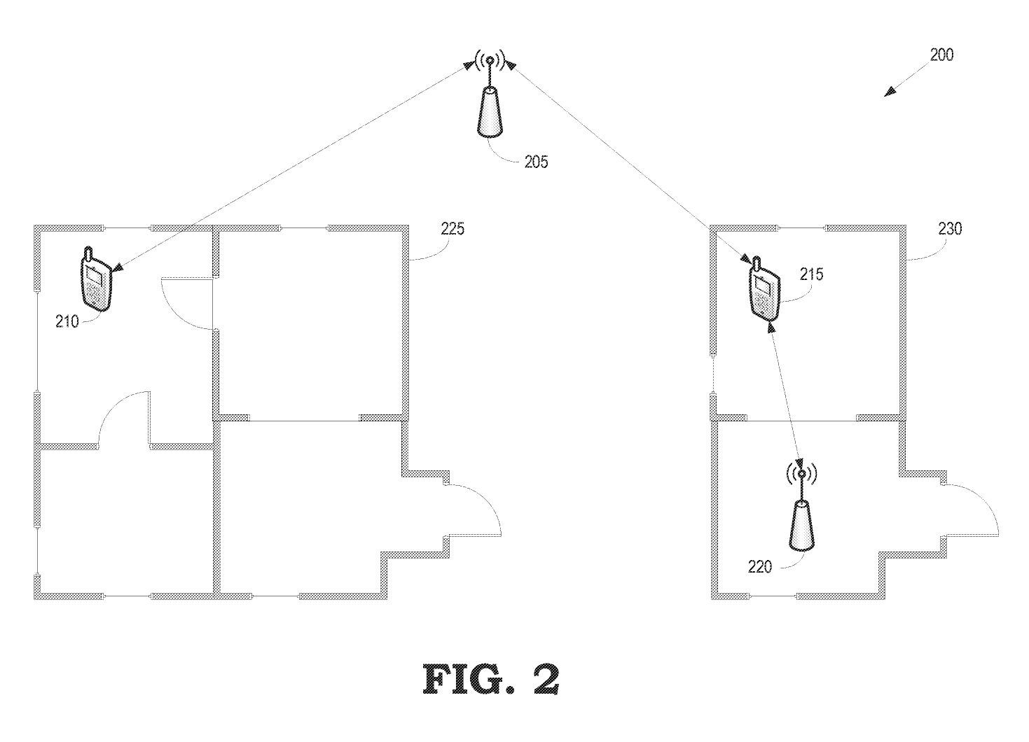

FIG. 2 is a diagram of a second example of a wireless communication system 200 according to some embodiments. In the illustrated embodiment, an access point 205 is used to provide wireless connectivity to a corresponding geographic area or cell, which may include user equipment 210, 215 that can communicate with the access point 205 in both licensed frequency bands and unlicensed frequency bands. The wireless communication system 200 also includes one or more access points 220 that can communicate with user equipment 210, 215 in at least the unlicensed frequency bands. As used herein, the term “access point” is understood to refer to a node or a device that provides wireless connectivity to the user equipment 210, 215 or other nodes within a corresponding geographic area. The term “access point” may therefore encompass base stations, base station routers, eNodeBs, macrocells, microcells, femtocells, picocells, and other types of devices. Wireless connectivity in the licensed frequency bands may be provided according to the 3GPP standards such as LTE and wireless connectivity in the unlicensed frequency bands may be provided according to Wi-Fi standards, IEEE 802 standards, or other communication standards. In some embodiments, the access points 205, 220 or the user equipment 210, 215 may correspond to one or more of the nodes 101-104 shown in FIG. 1.

Buildings 225, 230 may be located within one or more of the geographic areas served by the access points 205, 220. As discussed herein, obstructions such as the doors, windows, or walls of the buildings 225, 230 may significantly increase channel loss between the user equipment 210, 215 and the access points 205, 220. Exemplary building penetration losses are typically on the order of 11-20 dB. For a given transmission power, the penetration losses may make it difficult or impossible for the access points 205, 220 to detect each other's presence. The access points 205, 220 may therefore be hidden from each other. Downlink transmissions in the unlicensed frequency bands from the access points 205, 220 may therefore collide at the user equipment 215. Thus, as discussed herein, some embodiments of the access point 205 may use communications in the licensed frequency bands to configure the user equipment 215 to proactively monitor the unlicensed frequency bands and provide signals indicating whether some or all of the unlicensed frequency bands are clear for wireless communication.

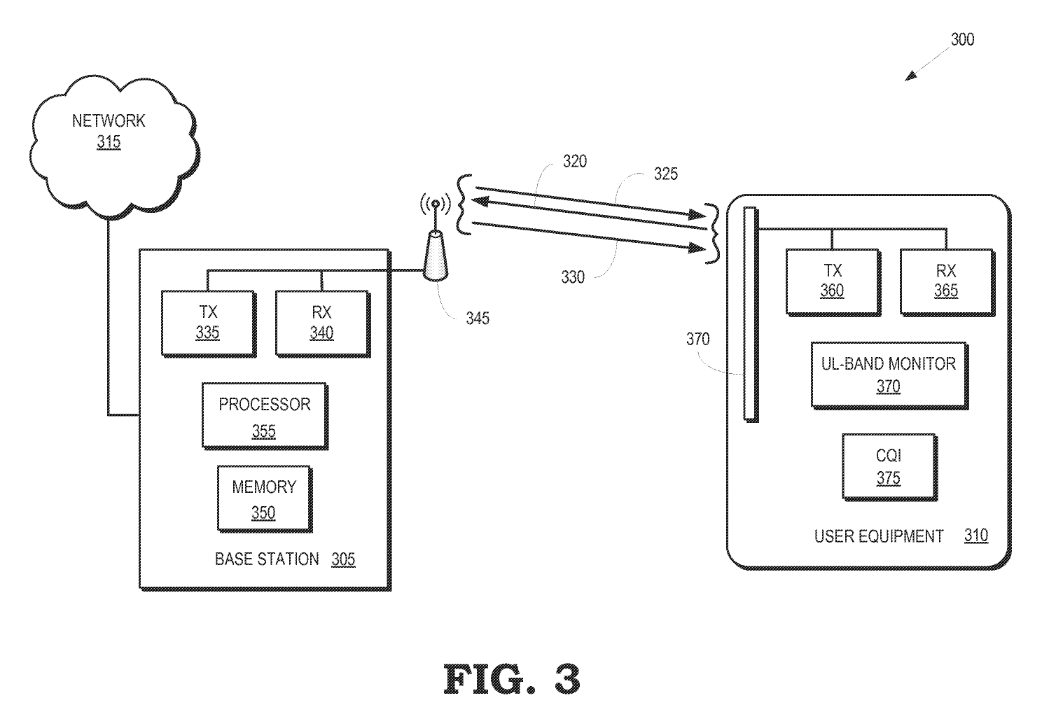

FIG. 3 is a diagram of a third example of a wireless communication system 300 according to some embodiments. The wireless communication system 300 includes a base station 305 that supports wireless connectivity to user equipment 310. User equipment 310 may access network 315 by exchanging signals over an air interface with the base station 305. Some embodiments of the base station 305 or the user equipment 310 may correspond to one or more of the nodes 101-104 shown in FIG. 1. The base station 305 and the user equipment 310 may communicate over one or more uplink channels 320 and one or more downlink channels 325 in a licensed frequency band. The base station and the user equipment 310 may also communicate over a supplementary downlink channel 330 in an unlicensed frequency band.

Some embodiments of the base station 305 include a transmitter (TX) 335 and a receiver (RX) 340 that are coupled to an antenna 345. The transmitter 335 may therefore transmit signals over the downlink channels 325 in the licensed frequency band or the supplementary downlink channel 330 in the unlicensed band. The receiver 340 may receive signals over the uplink channels 320. The base station 305 includes memory 350 for storing information such as processor instructions, data for transmission, received data, and the like. A processor 355 may be used to process information for transmission, process received information, or perform other operations, e.g., by executing instructions stored in the memory 360.

Some embodiments of the processor 355 may be used to generate configuration information that is used to configure the user equipment 310 to proactively monitor the downlink channel 330 of the unlicensed frequency bands and provide signals indicating whether the downlink channel 330 is clear for wireless communication. Configuration information may include information identifying one or more unlicensed frequency bands, one or more subsets of an unlicensed frequency bands such as one or more 20 MHz blocks of a 400 MHz unlicensed frequency band that are to be monitored in different time intervals, one or more periodicities for measuring or sensing one or more unlicensed frequency bands and reporting the results to the base station 305, and the like. For example, the user equipment 310 may be configured to sequentially monitor different 20 MHz blocks of a 400 MHz unlicensed frequency band in successive time intervals. For another example, the user equipment 310 may be configured to sense the unlicensed frequency band and provide a report indicating whether the unlicensed frequency band is clear at intervals or with periodicities such as 2 milliseconds (ms), 5 ms, or 10 ms. The number of subsets of the unlicensed frequency bands or the periodicities for measuring signals in the unlicensed frequency bands may be determined based on properties such as the power consumption in the user equipment 310 needed to perform the requested measurements.

Some embodiments of the processor 355 may be used to generate configuration information that configures the user equipment 310 to provide the feedback indicating whether the downlink channel 330 is clear as part of channel state information (CSI) feedback provided by the user equipment 310. The user equipment 310 may also be configured to determine and feedback channel quality information (CQI) for the downlink channel 330. For example, the user equipment 310 may be configured to provide 1 bit indicating whether the downlink channel 330 is clear (e.g., 0 indicating that the channel is not clear and 1 indicating that the channel is clear) and 4 bits indicating whether the channel quality is poor (e.g., 0000 indicating the lowest channel quality) or good (e.g., 1111 indicating the highest channel quality). Some embodiments of the user equipment may be configured to provide the feedback only when the downlink channel 330 is clear.

The processor 355 may also be used to process signals received from the user equipment 310 to determine whether the downlink channel 330 is clear for transmission of data to the user equipment 310. For example, in response to receiving data for transmission to the user equipment 310, the processor 355 may access the feedback received from the user equipment 310 to determine whether the supplementary downlink channel 330 is clear. If so, the processor 355 may cause the base station 305 to transmit the data to the user equipment 310 over the supplementary downlink channel 330. The processor 355 may also be able to choose from among available subsets of the unlicensed frequency bands. For example, if the user equipment 310 returns feedback indicating that a first subset of the unlicensed frequency band is clear and a second subset of the unlicensed frequency band is not clear, the processor 355 may choose the first subset and caused the base station 305 to transmit the data to the user equipment 310 over the supplementary downlink channel 330 using the first subset of the unlicensed frequency band. The processor 355 may also use information such as CQI to prioritize different subsets of the unlicensed frequency band for downlink transmissions. Some embodiments of the processor 355 may be used to perform other operations, as discussed herein.

Some embodiments of the user equipment 310 include a transmitter (TX) 360 and a receiver (RX) 365 that are coupled to an antenna 370. The transmitter 360 may transmit signals over the uplink channel 320 in the licensed frequency band. The receiver 365 may receive signals over the downlink channel 325 in the licensed frequency band and the supplementary downlink channel 330 in the unlicensed frequency band. The user equipment 310 includes an unlicensed (UL) band monitor 375 that can be used to determine whether the supplementary downlink channel 330 is clear or not. Techniques for determining whether the channels of unlicensed frequency bands are clear for transmission by measuring or sensing the unlicensed frequency bands are known in the art. For example, the receiver 365 and the unlicensed band monitor 370 may be used to measure of signal strength on the supplementary downlink channel 330 during timing gaps or measurement gaps in which the transmitter 360 does not transmit in at least a portion of the unlicensed frequency band. The measurements may be used to determine whether the supplementary downlink channel 330 is clear for transmission. The user equipment may also include CQI logic 375 for determining CQI values for the downlink channel 325 for the supplementary downlink channel 330.

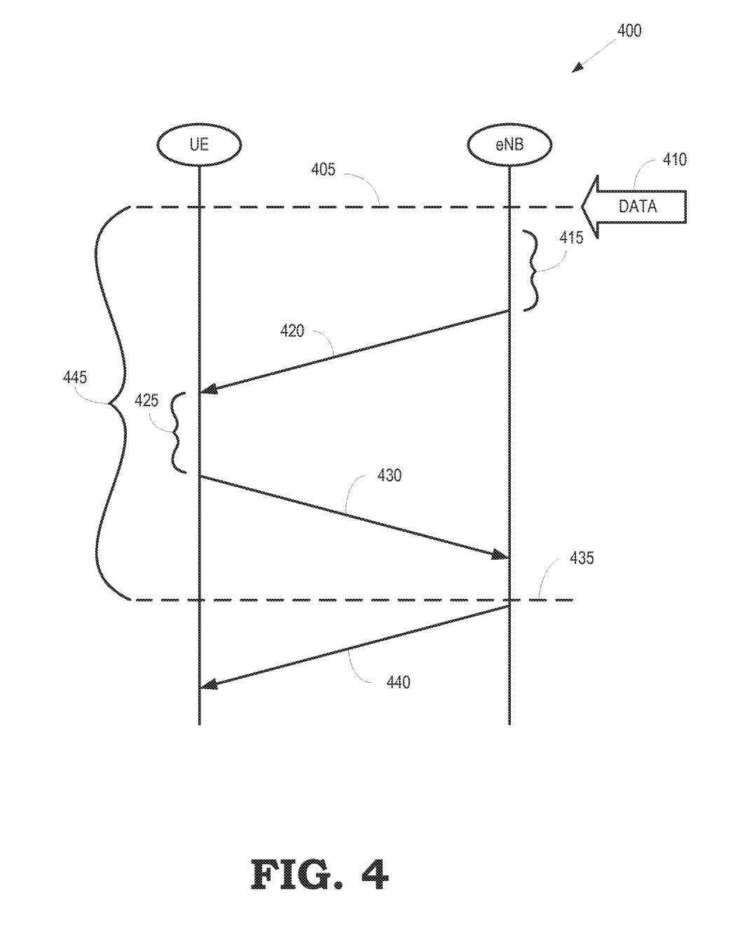

FIG. 4 is a signaling diagram that illustrates a conventional request-to-send/clear-to-send (RTS/CTS) signal flow for communication in an unlicensed frequency band. The signals in the signal flow 400 are transmitted over an unlicensed frequency band between user equipment (UE) and a base station or eNodeB (eNB), which may correspond to the nodes 101-104 shown in FIG. 1. At dashed line 405, the eNB receives data 410 for transmission to the UE over the unlicensed frequency band. The eNB senses the unlicensed frequency band to determine whether the unlicensed frequency band is clear for transmission, which results in a delay 415. Once the eNB determines that the unlicensed frequency band is clear, the eNB transmits a request-to-send (RTS) message to the UE, as indicated by the arrow 420. In response to receiving the RTS message, the UE senses the unlicensed frequency band to determine whether the unlicensed frequency band is clear for transmission from the UE's perspective, which causes an additional delay 425. If the UE determines that the unlicensed frequency band is clear, the UE sends a clear-to-send (CTS) message to the eNB, as indicated by the arrow 430. In response to receiving the CTS message, the eNB transmits the data 410 at 435, as indicated by the arrow 440. Consequently, using the RTS/CTS message exchange to determine whether the unlicensed frequency band is clear results in a total delay 445 between the eNB's reception of the data at 405 and transmission of the data to the UE at 435. Furthermore, the signals 420, 430, 440 may interfere with other communications in the unlicensed frequency band.

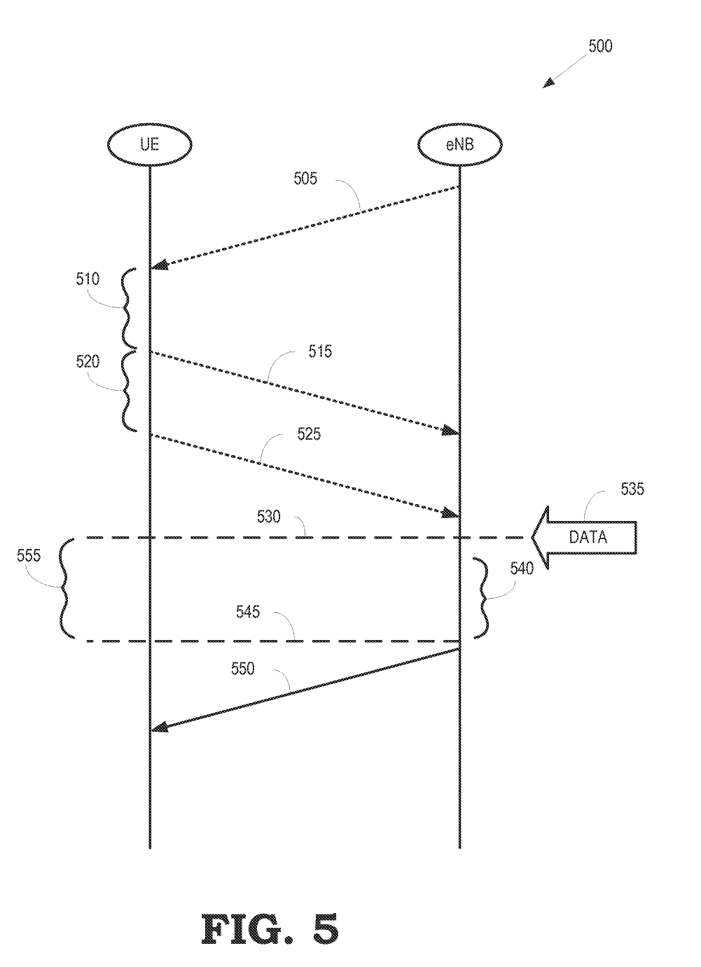

FIG. 5 is a signaling diagram that illustrates a first example of a signal flow 500 for configuring proactive monitoring and reporting for an unlicensed frequency band according to some embodiments. The signals in the signal flow 500 indicated by the dotted lines are transmitted over a licensed frequency band between user equipment (UE) and a base station or eNodeB (eNB), which may correspond to the nodes 101-104 shown in FIG. 1. The signals in the signal flow indicated by solid lines are transmitted over an unlicensed frequency band between the UE and the eNB. Prior to the eNB receiving data for transmission to the UE over the unlicensed frequency band, the eNB transmits configuration information to configure the UE to sense the unlicensed frequency band (or one or more subsets thereof, as discussed herein) and report whether the unlicensed frequency band is clear. As indicated by the dotted line 505, the configuration information is transmitted over the licensed frequency band and consequently causes no interference to communications in the unlicensed frequency band.

In response to receiving the configuration information, the UE senses the unlicensed frequency band to determine whether the unlicensed frequency band is clear for transmission from the UE's perspective, which causes a delay 510. Since no data is waiting for transmission at the eNB, the delay 510 does not introduce any latency into the data transmission between the eNB and the UE. The UE transmits an indication of whether the unlicensed frequency band is clear. Some embodiments of the UE may also transmit CQI information for the unlicensed frequency band. As indicated by the dotted line 515, the clear indication and (optionally) the CQI information are transmitted over the licensed frequency band and consequently cause no interference to communication in the unlicensed frequency band. The UE may subsequently (or periodically) repeat the measurement of the signals in the unlicensed frequency band after a delay 520 and report the clear indication and (optionally) the CQI information over the licensed frequency bands, as indicated by the dotted line 525.

At dashed line 530, the eNB receives data 535 for transmission to the UE over the unlicensed frequency band. The eNB has already received an indication that the unlicensed frequency band is clear (the signal 525) and so the eNB may transmit the data 535 substantially immediately. In the illustrated embodiment, the eNB elects to sense the unlicensed frequency band to verify that the unlicensed frequency band is clear prior to transmitting the data, which introduces the delay 540. If the eNB verifies that the unlicensed frequency band is clear, the eNB transmits the data 535 to the UE at line 545. As indicated by the solid line arrow 550, the data 535 is transmitted over the unlicensed frequency band. The delay 555 between receiving the data at 530 and transmitting the data at 545 is significantly smaller than the total delay 445 for the RTS/CTS signaling protocol depicted as FIG. 4. Some embodiments of the eNB may back off if the eNB determines that the unlicensed frequency band is no longer clear when the eNB senses the unlicensed frequency band at 540. The eNB may then re-sense the unlicensed frequency band at specified time intervals and transmit the data over the unlicensed frequency band when the unlicensed frequency band becomes clear.

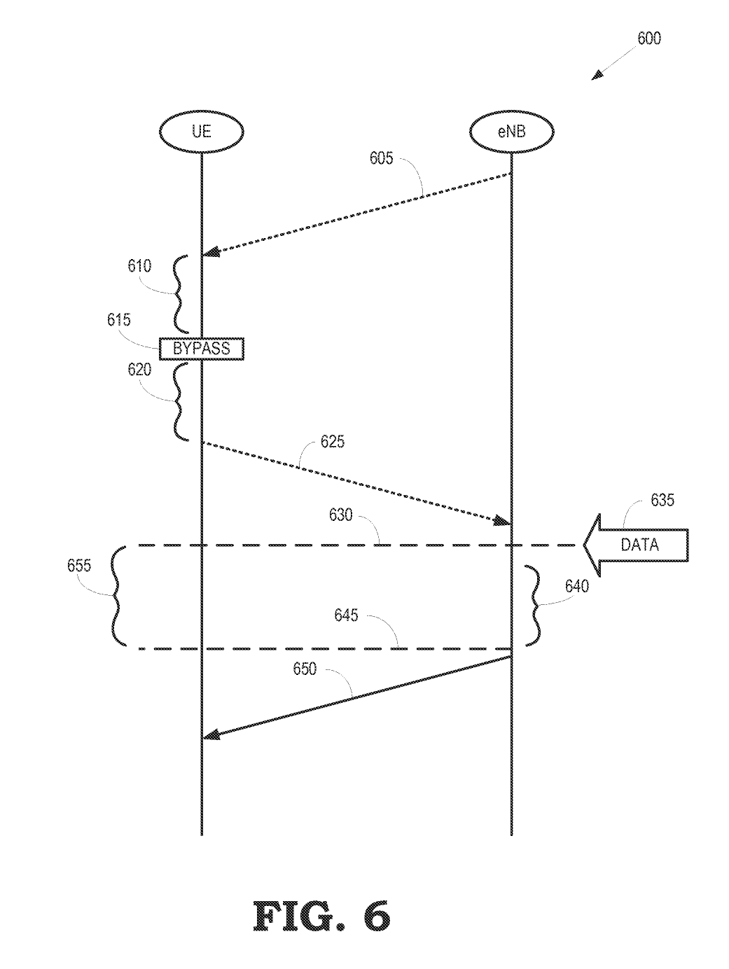

FIG. 6 is a signaling diagram that illustrates a second example of a signal flow 600 for configuring proactive monitoring and reporting for an unlicensed frequency band according to some embodiments. The signals in the signal flow 600 indicated by the dotted lines are transmitted over a licensed frequency band between a UE and an eNB, which may correspond to the nodes 101-104 shown in FIG. 1. The signals in the signal flow indicated by solid lines are transmitted over an unlicensed frequency band between the UE and the eNB. Prior to the eNB receiving any data for transmission to the UE over the unlicensed frequency band, the eNB transmits configuration information to configure the UE to sense the unlicensed frequency band (or one or more subsets thereof, as discussed herein) and report whether the unlicensed frequency band is clear. As indicated by the dotted line 605, the configuration information is transmitted over the licensed frequency band and consequently causes no interference to communications in the unlicensed frequency band.

In response to receiving the configuration information, the UE senses the unlicensed frequency band to determine whether the unlicensed frequency band is clear for transmission from the UE's perspective, which causes a delay 610. Since no data is waiting for transmission at the eNB, the delay 610 does not introduce any latency into the data transmission between the eNB and the UE. The UE determines that the unlicensed frequency band is not clear and therefore bypasses (at 615) transmission of a clear indication to the eNB. Bypassing transmission of the clear indication may reduce the signaling overhead in the licensed frequency bands. The UE may subsequently (or periodically) repeat the measurement of the signals in the unlicensed frequency band after a delay 620. In the illustrated embodiment, the UE determines that the unlicensed frequency band is clear using measurements performed during the delay 620. The UE reports the clear indication and (optionally) the CQI information over the licensed frequency bands. As indicated by the dotted line 615, the clear indication and (optionally) the CQI information are transmitted over the licensed frequency band and consequently cause no interference to communication in the unlicensed frequency band.

At dashed line 630, the eNB receives data 635 for transmission to the UE over the unlicensed frequency band. The eNB has already received an indication that the unlicensed frequency band is clear (the signal 625) and so the eNB may transmit the data 635 substantially immediately. In the illustrated embodiment, the eNB elects to sense the unlicensed frequency band to verify that the unlicensed frequency band is clear prior to transmitting the data, which introduces a delay 640. If the eNB verifies that the unlicensed frequency band is clear, the eNB transmits the data 635 to the UE at line 645. As indicated by the solid line arrow 650, the data 635 is transmitted over the unlicensed frequency band. The delay 655 between receiving the data at 630 and transmitting the data at 645 is significantly smaller than the total delay 445 for the RTS/CTS signaling protocol depicted as FIG. 4.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
providing, from a node in a wireless communication system and over a licensed frequency band, an indication of whether at least one unlicensed frequency band is clear for wireless communication.

2. The method of claim 1, wherein providing the indication comprises providing the indication prior to data becoming available for transmission to the node over the at least one unlicensed frequency band.

3. The method of claim 1, further comprising:
configuring the node to monitor the at least one unlicensed frequency band based on information received over the licensed frequency band.

4. The method of claim 3, wherein configuring the node to monitor the at least one unlicensed frequency band comprises configuring the node to periodically monitor the at least one unlicensed frequency band.

5. The method of claim 4, wherein configuring the node to periodically monitor the at least one unlicensed frequency band comprises configuring the node to monitor the at least one unlicensed frequency band with a periodicity determined based on power consumption at the node.

6. The method of claim 3, wherein the at least one unlicensed frequency band is at least one of a plurality of frequency bands, and wherein configuring the node to monitor the at least one frequency band comprises configuring the node to monitor a subset of the plurality of frequency bands.

7. The method of claim 6, wherein configuring the node to monitor the at least one frequency band comprises configuring the node to monitor different subsets of the plurality of frequency bands in different time intervals.

8. The method of claim 1, further comprising:
determining channel quality information (CQI) based on measurements of the at least one unlicensed frequency band; and
providing the CQI over the licensed frequency band in conjunction with providing the indication of whether the at least one unlicensed frequency band is clear.

9. The method of claim 1, wherein providing the indication comprises providing the indication in response to the at least one unlicensed frequency band being clear for wireless communication and bypassing providing the indication in response to the at least one unlicensed frequency band not being clear.

10. A method comprising:
receiving, at a first node in a wireless communication system and over a licensed frequency band, an indication of whether at least one unlicensed frequency band is clear for wireless communication.

11. The method of claim 10, wherein receiving the indication comprises receiving the indication prior to data becoming available for transmission to a second node over the at least one unlicensed frequency band.

12. The method of claim 11, further comprising:
providing, over the licensed frequency band, information to configure the second node to monitor the at least one unlicensed frequency band.

13. The method of claim 12, wherein providing the information to configure the second node comprises providing information to configure the second node to periodically monitor the at least one unlicensed frequency band.

14. The method of claim 13, wherein providing the information to configure the second node to periodically monitor the at least one unlicensed frequency band comprises providing the information to configure the second node to monitor the at least one unlicensed frequency band with a periodicity determined based on power consumption at the second node.

15. The method of claim 12, wherein the at least one unlicensed frequency band is at least one of a plurality of frequency bands, and wherein providing the information to configure the second node to monitor the at least one frequency band comprises providing the information to configure the second node to monitor a subset of the plurality of frequency bands.

16. The method of claim 15, wherein providing the information to configure the second node to monitor the at least one frequency band comprises providing the information to configure the second node to monitor different subsets of the plurality of frequency bands in different time intervals.

17. The method of claim 11, further comprising:
receiving channel quality information (CQI) over the licensed frequency band in conjunction with receiving the indication of whether the at least one unlicensed frequency band is clear, wherein the second node determines the CQI based on measurements of the at least one unlicensed band.

18. The method of claim 10, wherein receiving the indication comprises receiving the indication in response to the at least one unlicensed frequency band being clear for wireless communication.

19. A node for wireless communication to provide, over a licensed frequency band, an indication of whether at least one unlicensed frequency band is clear for wireless communication.

20. A node for wireless communication to receive, over a licensed frequency band, an indication of whether at least one unlicensed frequency band is clear for wireless communication.
